(19) United States
(12) Patent Application Publication
(10) Pub. No.: US 2017/0116226 A1
(43) Pub. Date: Apr. 27, 2017

(54) LINKED DATA DRIVEN SEMANTIC DATA STORAGE AND ACCESS UTILIZING HORIZONTAL PROPERTY REIFICATION

(71) Applicant: OSTHUS INC., Plantation, FL (US)

(72) Inventors: Wolfgang Colsman, Aachen (DE); Jochen Hormes, Aachen (DE)

(21) Appl. No.: 14/923,703

(22) Filed: Oct. 27, 2015

(51) Int. Cl. G06F 17/30

(52) U.S. Cl. CPC G06F 17/30289; G06F 17/30371

(57) ABSTRACT

Embodiments of the invention provide a novel method, system and computer program product for linked data driven semantic data storage and access utilizing horizontal reification. In an embodiment of the invention, the method includes creating data for linked data access in a data store and computing meta-data regarding the created data. The method additionally includes encapsulating the created data and the meta-data into a set of multiple different triples. Finally, the method includes reducing the set of multiple different triples pertaining to the created data into a single multi-column record specifying the created data combined with additional columns referencing reification data.

### BACKGROUND OF THE INVENTION

Field of the Invention

The present invention relates to controlled data access and more particularly to linked data driven data access.

Description of the Related Art

The term “linked data” refers to a set of best practices for publishing structured data on the World Wide Web. The best practices include the use of uniform resource identifiers (URIs) in naming data, the use of hypertext transfer protocol (HTTP) URIs so as to enabled end users to query the data by name, the provision of information in response to the querying of data by URI, and the linking of different named data by URI so as to permit peer-to-peer navigation and discovery of related data. The linked data set of best practices exists as a standard for data representation and access in the World Wide Web and to support the generation of a massive global data graph of all data present and accessible in the World Wide Web in order to create a single global information space.

Despite the grand design of linked data, it is to be recognized that not all data exists in an equivalent computing environment. In some computing environments, data is intended to be freely accessible, navigable and retrievable. In other computing environments, data is intended to be restricted in terms of access, navigation and retrieval. Thus, the utility of linked data is limited to those computing environments more permissive with respect to the practice of data access, whereas more stringent enterprise computing environments—especially those in government or regulated industries cannot necessarily enjoy the benefit of linked data.

### BRIEF SUMMARY OF THE INVENTION

Embodiments of the present invention address deficiencies of the art in respect to linked data and provide a novel and non-obvious method, system and computer program product for linked data driven semantic data storage and access utilizing horizontal reification. In an embodiment of the invention, a method for linked data driven semantic data storage and access utilizing horizontal reification is provided. The method includes creating data for linked data access in a data store and computing meta-data regarding the created data. The method additionally includes encapsulating the created data and the meta-data into a set of multiple different triples by the triple store. Finally, the method includes reducing the set of multiple different triples by the triple store pertaining to the created data into a single multi-column record specifying the created data combined with additional columns referencing reification data, for instance a reification uniform resource identifier (URI), an identity of an end user creating the created data and a creation time and/or date of the created data.

In one aspect of the embodiment, the method additionally includes receiving from a requestor from over a computer communications network, a linked data request to retrieve the created data. Thereafter, the multi-column record storing the created data is identified and expanded into a set of multiple different triples by the triple store using the reification data referenced in the additional columns. In one aspect of the embodiment, the triples are reduced by removing redundantly present data by the triple store, and wherein the multi-column record is expanded by adding the removed redundantly present data. Finally, the data in the triple store is returned to the requestor over the computer communications network.

In another embodiment of the invention, a data processing system is configured for linked data driven semantic data storage and access utilizing horizontal reification. The system includes a host computing system that has at least one computer with memory and at least one processor. The host computing system optionally is communicatively coupled to other computers over a computer communications network. The system also includes a database coupled to the host computing system and storing linked data. Finally, the system includes a linked data driven semantic data storage and access module executing in the memory of the host computing system. The module includes program code enabled to create data for linked data access in a data store, to compute meta-data regarding the created data, to encapsulate the created data and the meta-data into a set of multiple different triples by the triple store, and to reduce the set of multiple different triples by the triple store pertaining the created data into a single multi-column record specifying the created data combined with the meta-data.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for linked data driven semantic data storage and access utilizing horizontal reification;

FIG. 2 is a pictorial illustration of a process for reducing one triple and its meta-data (reification data) in the triple store into a single multi-column row.

FIG. 3 is a schematic illustration of a data processing system configured for linked data driven semantic data storage and access utilizing horizontal reification; and,

FIG. 4 is a flow chart illustrating a process for linked data driven semantic data storage and access utilizing horizontal reification.

### DETAILED DESCRIPTION OF THE INVENTION

Embodiments of the invention provide for linked data driven semantic data storage and access utilizing horizontal reification. In accordance with an embodiment of the invention, data is created for linked data access in a data store. Meta-data regarding the created data also is provided, for example meta-data specifying the creator of the data and a timestamp and/or datestamp when the data is created. The created data is received as multiple different triples for storage in a triple store and the meta-data is also received as multiple different triples for storage in the same triple store. Thereafter, the triples pertaining to the created data each are combined with the corresponding meta-data values into a multi-column record of the data store through the elimination of redundantly present fields, namely the subject and predicate of the meta-data triples. Conversely, on retrieval, the multi-column record specifying the created data and combined with the corresponding meta-data is restored back into the multiple different triples including the redundantly present fields.

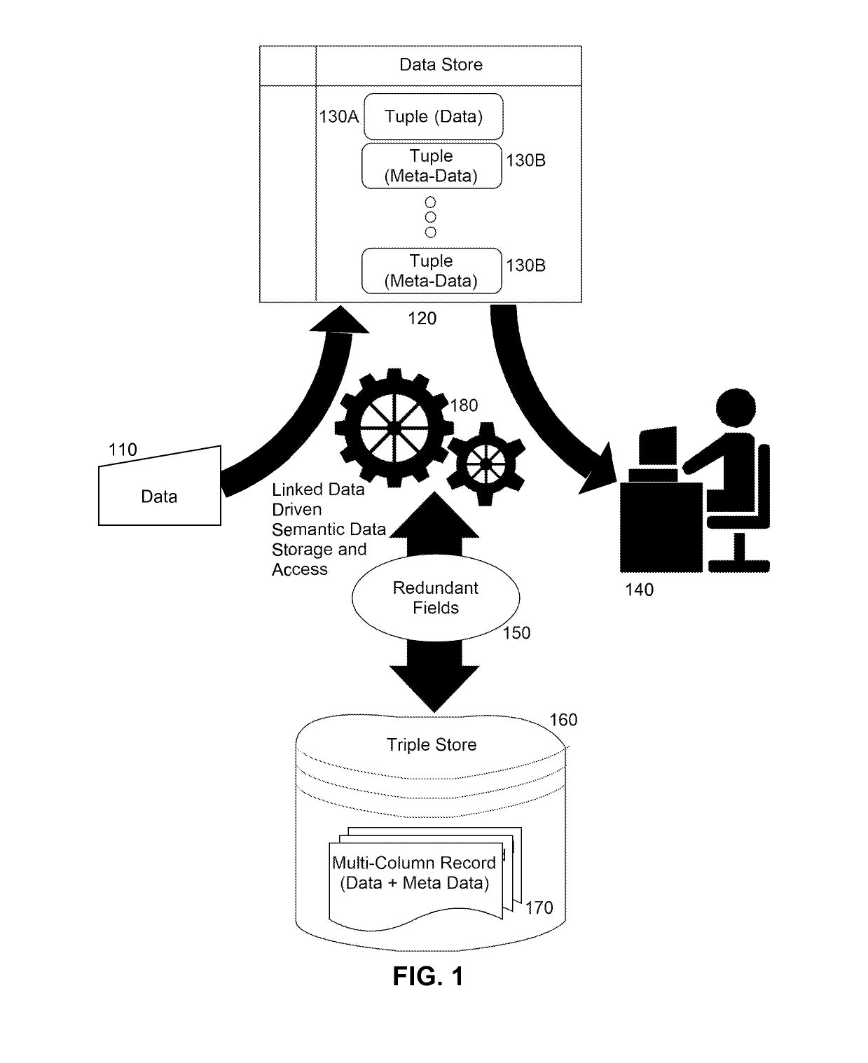

In further illustration, FIG. 1 is a pictorial illustration of a process for linked data driven semantic data storage and access utilizing horizontal reification. As shown in FIG. 1, data 110 can be requested by a data consumer 140 and located in a data store 160. The triple store 160 includes different multi-column records 170 for different data including the requested data 110. Linked data driven semantic data storage and access logic 180 expands the desired one of the multi-column records 170 into multiple different triples 130A, 130B for placement in a data store 120. The data store 120 includes first triple 130A pertaining to the data 110 and a set of triples 130B pertaining to meta-data regarding the data 110. The triples 130A, 130B are derived from the desired one of the different multi-column records 170 but include inserted redundant fields 150 previously stripped from the triples 130B of the triple store 120 in producing the desired one of the different multi-column records 170 as well as reification data appended to the desired one of the different multi-column records 170. Thereafter, the linked data driven semantic data storage and access logic 180 returns the triples 130A, 130B of the data store 120 to the data consumer 140 as linked data.

Conversely, the data consumer 140 can request storage of the data 110 and provides the data 110 in the data store 120 to the linked data driven semantic data storage and access logic 180. The linked data driven semantic data storage and access logic 180 in turn reduces the data 110 in the data store 120 by discarding the redundant fields 150 in order to produce a corresponding one of the multi-column records 170. Additionally, in addition to the triple 130 containing the data 110, reification data corresponding to the data 110 is appended to the triple 130A in order to form the corresponding one of the different multi-column records 170 which is then stored in the triple store 160.

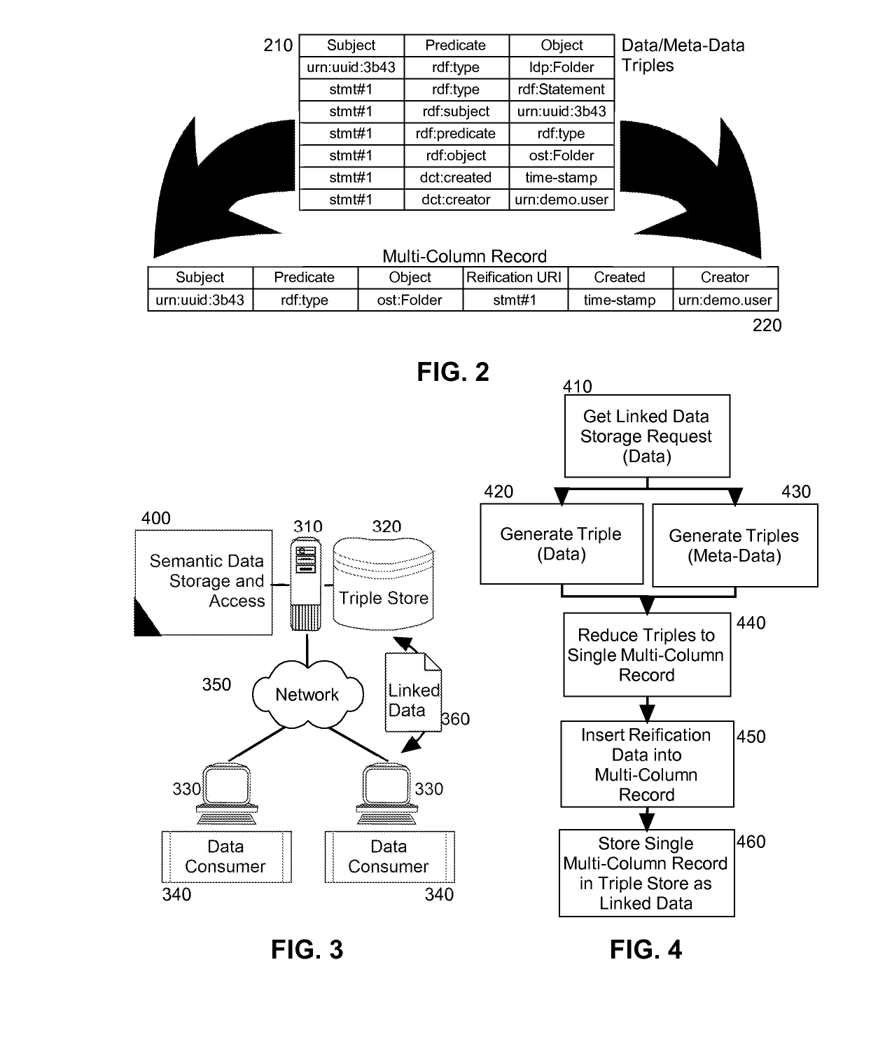

In more particular illustration of the reduction of the triple store 120 into one of the corresponding one of the different multi-column records 170, FIG. 2 is a pictorial illustration of a process for reducing each data triple of a data storage operation into a single multi-column record with appended reification data. As shown in FIG. 2, a data store 210 includes a set of triples for linked data—namely each a subject, a predicate and an object. The first triple of the data store 210 provides for a unique resource name of the linked data itself as the subject referring to its encapsulating folder. The second triple provides for reification data and the subsequent third, forth and fifth triples include redundant information. The objects of the sixth and seventh triples include the remaining required reification data so that content of the data store 210 then is reduced by including in a single multi-column record 220, a subject of the uniform resource name of the created data and as its object and predicate, and then by appending thereto reification data present in the data store 210 while omitting all other redundant data.

The process described in connection with FIGS. 1 and 2 can be implemented in a data processing system. In yet further illustration, FIG. 3 is a schematic illustration of a data processing system configured for linked data driven semantic data storage and access utilizing horizontal reification. The system includes a host computing system 310 that includes one or more different computers, each with memory and one or more processors. The host computing system 310 may be coupled to different client computers 330 over computer communications network 350. The host computing system 310 is coupled to a triple store 320 such as a database that stores therein linked data 360 configured for access by different data consumer applications 340 disposed in respectively different ones of the client computers 330.

Of note, the host computing system 310 supports the operation of a semantic data storage and access module 400. The module 400 includes program code enabled upon execution in the memory of the host computing system 310 to create linked data 360 for linked data access in the triple store 320. Meta-data regarding the created linked data 360 also is provided, for example meta-data specifying the creator of the data and a timestamp and/or datestamp when the data is created. In this regard, the created data is received by the program code of the module 400 for storage as multiple different triples in a triple store.

Thereafter, the program code of the module 400 reduces the triples in the data store pertaining to the created data through the elimination of redundantly present fields so as to produce a single multi-column record specifying the created data combined with the corresponding meta-data. The program code of the module 400 further appends to the single multi-column record three columns of reification data pertaining to the created data. Conversely, on retrieval, the program code of the module 400 restores from the single multi-column record the multiple different triples including the redundantly present fields as is the single multi-column record pertaining to the created data itself as well as the reification data appended to the single multi-column record.

In even yet further illustration of the operation of the semantic data storage and access module 400, FIG. 4 is a flow chart illustrating a process for linked data driven semantic data storage and access utilizing horizontal reification. Beginning in block 410, a request to store linked data is received specifying a uniform resource name of the desired linked data and the data itself. In block 420, triples are generated for the data and meta-data pertaining to the data in block 430, such as a time of creation of the data and a creator of the data. In block 440, the triples are reduced to a single multi-column record for the data and the meta-data by removing redundant fields of the triples. Thereafter, in block 450, three columns of reification data are appended to each of the single multi-column records. Finally, in block 460 the multi-column records are stored in the triple store. In this way, the linked data platform can be utilized in a computing environment requiring audit capabilities without overtaxing the storage capacity of the data store.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

Computer readable program instructions described herein can be downloaded to respective computing/processing devices from a computer readable storage medium or to an external computer or external storage device via a network. The computer readable program instructions may execute entirely on the user's computer, partly on the user's computer, as a stand-alone software package, partly on the user's computer and partly on a remote computer or entirely on the remote computer or server. Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for linked data driven semantic data storage and access utilizing horizontal reification, comprising:
creating data for linked data access in a data store;
computing meta-data regarding the created data;
encapsulating the created data and the meta-data into a set of multiple different triples in a triple store; and,
reducing the set of multiple different triples in the triple store pertaining to the created data into a single multi-column record specifying the created data combined with additional columns referencing reification data.

2. The method of claim 1, further comprising:
receiving from a requestor from over a computer communications network, a linked data request to retrieve the created data;
identifying the multi-column record in the triple store storing the created data;
expanding the multi-column record into a set of multiple different triples using the reification data referenced in the additional columns; and,
returning the set of triples to the requestor over the computer communications network.

3. The method of claim 2, wherein the triples are reduced by removing redundantly present data in the meta-data of the data triples, and wherein the multi-column record is expanded by adding the removed redundantly present data.

4. The method of claim 1, wherein the reification data includes a reification uniform resource identifier (URI) and an identity of an end user creating the created data.

5. A data processing system configured for linked data driven semantic data storage and access utilizing horizontal reification, the system comprising:
a host computing system comprising at least one computer with memory and at least one processor, the host computing system being communicatively coupled to other computers over a computer communications network;
a database coupled to the host computing system and storing linked data; and,
a linked data driven semantic data storage and access module executing in the memory of the host computing system, the module comprising program code enabled to create data for linked data access in a data store, to compute meta-data regarding the created data, to encapsulate the created data and the meta-data into a set of multiple different triples in a set of triples, and to reduce the set of multiple different triples pertaining to the created data into a single multi-column record specifying the created data combined with additional columns referencing reification data.

6. The system of claim 5, wherein the program code of the module is further enabled to receive from a requestor from over a computer communications network, a linked data request to retrieve the created data, to identify the multi-column record storing the created data, to expand the multi-column record into a set of multiple different using the reification data referenced in the additional columns, and to return the resulting set of triples to the requestor over the computer communications network.

7. The system of claim 6, wherein the triples are reduced by removing redundantly present data in the meta-data, and wherein the multi-column record is expanded by adding the removed redundantly present data.

8. The system of claim 6, wherein the reification data includes a reification uniform resource identifier (URI) and an identity of an end user creating the created data.

9. A computer program product for linked data driven semantic data storage and access utilizing horizontal reification, the computer program product comprising a computer readable storage medium having program instructions embodied therewith, the program instructions executable by a device to cause the device to perform a method comprising:
creating data for linked data access in a data store;
computing meta-data regarding the created data;
encapsulating the created data and the meta-data into a set of multiple different triples; and,
reducing the set of multiple different triples pertaining to the created data into a single multi-column record specifying the created data combined with the meta-data.

10. The computer program product of claim 9, wherein the method further comprises:
receiving from a requestor from over a computer communications network, a linked data request to retrieve the created data;
identifying the multi-column record storing the created data;
expanding the multi-column record into a set of multiple different triples using the reification data referenced in the additional columns; and,
returning the resulting set of triples to the requestor over the computer communications network.

11. The computer program product of claim 10, wherein the triples are reduced by removing redundantly present data in the meta-data, and wherein the multi-column record is expanded by adding the removed redundantly present data.

12. The computer program product of claim 9, wherein the reification data includes a reification uniform resource identifier (URI) and an identity of an end user creating the created data.
